(19) United States
(12) Patent Application Publication
(10) Pub. No.: US 2005/0232732 A1
(43) Pub. Date: Oct. 20, 2005

(54) Intermediate store

(76) Inventor: Kurt Philipp, Grenzach-Wyhlen (DE)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/027,928

(22) Filed: Dec. 29, 2004

(30) Foreign Application Priority Data
Apr. 14, 2004 (CH) 00646/04

(51) Int. Cl. B65G 1/00

(52) U.S. Cl. 414/331.09

(57) ABSTRACT

The intermediate store has an input station for loading and an output station for unloading transport racks circulating in buffer zones between these two stations. The two stations each have a vertical conveyor for the transport racks, each of the two vertical conveyors being equipped with two pairs of chains driven independently of one another. The two pairs of chains in the input station alternately transport one transport rack each stepwise past a loading device and subsequently, after being decoupled from synchronous operation, transport them further, with the result that loading of the transport racks without interruption is permitted. The output station is formed analogously so that there too there are no interruptions between the emptying of two successive transport racks.

### BACKGROUND OF THE INVENTION

1. Field of the Invention

The invention relates to an intermediate store serving for flexible decoupling of the product flow between a production facility and a further processing station and having a transport rack with equidistant shelves,
comprising an input station having a loading device and an output station having an unloading device, these two stations each being equipped with a vertical conveyor for the transport rack,
and comprising two buffer conveyors arranged between these two stations intended for buffer zones containing the transport racks, a first one for the full transport racks and the second one for the empty transport racks,
and comprising aids for transferring the transport racks from the first vertical conveyor to the first buffer zone, from this to the second vertical conveyor, from this to the second buffer zone and from this to the first vertical conveyor.

2. Description of the Prior Art

It is known that small products in the form of piece goods, such as, for example, bakery products or chocolate bars, are transported in rows when being transferred from the production facility to a further treatment station, for example a packing station, so that the transport direction thereof is transverse to the axis of these product rows. A problem which inevitably occurs in transporting such products arises from the fact that it is practically impossibly to enable production and packing to operate synchronously. In particular, there will constantly be interruptions in the production sequence, and in the packing of these delicate goods, too, unforeseen or planned breaks cannot be avoided.

It was therefore at an early stage that the production facility was connected to the packing station by intermediate stores in which the goods produced can be temporarily stored and then called up when required by the packing personnel or the packing machine.

For transport, the products are stored in transport racks which are provided with a number of shelves for holding the products.

An intermediate store serving the above-mentioned purpose is disclosed in European Patent EP 0 732 279. The intermediate store described there has an input elevator which conveys the transport rack stepwise vertically past the infeed conveyor serving it and from there into a first buffer zone. An output elevator removes the full transport rack, as required, from the buffer zone and conveys it downward past a delivery device and, after emptying, into a second buffer zone. The planes defined by the chains of the two elevators are parallel to the direction of movement of the transport rack in the buffer zones.

According to this proposal, both the input elevator and the output elevator are each equipped with a pair of chains passed over at least four stationary deflection wheels. Each of these two pairs of chains has one continuously revolving chain each on each side of the transport path and is provided with drivers for picking up the transport rack delivered to the chain region. These therefore serve for loading a transport rack in the working cycle, for accepting the next transport rack and moreover for the horizontal displacement adjacent to the vertical movement in the upper and lower region. Although this design makes it possible to ensure that the elevators include not only a vertical movement component but also two horizontal movement components, and the number of individual drives are therefore reduced, this multiple function of the elevators results in an undesired influence on the processes taking place in the upper or lower transport region, which adversely affects the dynamics and flexibility of the system. Since in fact a rapid passage of the transport rack through the store is very desirable in most cases and the transport racks should therefore follow one another in the two elevators as far as possible without spaces, the known solution proves to be insufficiently flexible for minimizing the spaces between adjacent transport racks during vertical transport and, particularly at high throughput speeds, for ensuring a stable position of the transport racks.

Since it is impossible to avoid an undesired space between two successive transport racks in this arrangement, a further device has to be mounted to ensure continuous operation: the conveyor belt arranged at the entrance of the store is therefore formed to be pivotable in such a way that its free end is adjustable in height. However, this is associated with an additional constructional effort which moreover requires a further control to be derived from the movement of the transport racks.

### SUMMARY OF THE INVENTION

It is the object of the present invention to propose an intermediate store which permits uniform, continuous passage of the product without queues and hence creates the preconditions for maintaining a constant production speed. With a view to dynamic and independent control of the transport racks following one another during vertical transport, the elevator process should be controllable both in the input region and in the output region so that no spaces occur between vertically adjacent transport racks, ensuring a continuous production sequence.

This object is achieved by an intermediate store serving for flexible decoupling of the product flow between a production facility and a further processing station and having a transport rack with equidistant shelves,
comprising an input station having a loading device and an output station having an unloading device, these two stations each being equipped with a vertical conveyor for the transport rack,
comprising two buffer conveyors arranged between these two stations intended for buffer zones containing the transport racks, a first one for the full transport racks and the second one for the empty transport racks,
and comprising aids for transferring the transport racks from the first vertical conveyor to the first buffer zone, from this to the second vertical conveyor, from this to the second buffer zone and from this to the first vertical conveyor,
wherein each of the two vertical conveyors has two pairs of chains which are provided with drives independent of one another and all of which are arranged so that the planes defined by the two sides of a chain are perpendicular to the transport direction of the transport racks in the buffer zones,
wherein the drives of the vertical conveyors are controlled so that an empty transport rack transferred to the input station is moved by the first pair of chains, initially in synchronous operation corresponding to the shelf spacing, past the loading device and is loaded there and, after the end of loading, is decoupled from the synchronous operation and fed to the first buffer zone (12),
wherein the subsequent empty transport rack transferred to the input station is accepted by the second pair of chains and follows the preceding transport rack without a gap in the same synchronous operation, is likewise decoupled from the synchronous operation after the end of loading and is fed to the first buffer zone, wherein the following transport rack is in turn accepted by the first pair of chains,
and wherein the full transport racks transferred to the output station are moved in an analogous manner, alternately by the two pairs of chains, in synchronous operation, past the unloading device, are unloaded there and are then decoupled from the synchronous operation and fed to the second buffer zone.

The result of this design, according to the invention, of the intermediate store is that both at the input station and at the output station, each second transport rack following a first one can continuously accept the next product row arriving. This means that a product flow is possible with high cadence, continuously and without interruption, because an empty transport rack is always available. As soon as a transport rack has been loaded, it is immediately decoupled from the synchronous operation, moved upward and is placed into a first buffer zone, while at the same time, i.e. in a continuous procedure, an empty transport rack for synchronous filling is moved upward. Since the synchronous operation is therefore reduced to the straight-forward loading and unloading process, the products carried in the transport racks are accelerated only very slightly in the feed direction so that they cannot slip or fall down.

Even at the outflow of the intermediate store, the product can be ejected continuously, i.e. without interruption, in the direction of the packing station, since a full transport rack is always standing ready here. While a transport rack is being unloaded, the previously emptied transport rack, which has been decoupled, is simultaneously moved downward, unloaded and then transferred in the empty state to the second buffer zone. While both the loading and the unloading process can therefore take place without a break in synchronous operation, the vertical movement following the loading and preceding the unloading takes place in the same way as the preceding or subsequent horizontal movement. This ensures a smooth and hence safe flow of material.

The division of the complete vertical drive into two independently driven pairs of chains guarantees continuous conveying of the transport rack without queues and furthermore makes it possible, if required, to control the relative position of adjacent transport racks.

According to a preferred embodiment of the inventive concept, to enable two adjacent product rows located one above the other to be ejected on the unloading side simultaneously from the transport rack onto a horizontal conveyor, a storage plate which temporarily receives the upper product row and then transfers it to the horizontal conveyor is arranged above the horizontal conveyor.

In a preferred embodiment, a pusher bar which pushes the product rows placed on the conveyor belt, immediately after they have been set down, at the transport speed of the conveyor belt and thus prevents the individual rows from initially being transported at a speed which is lower than the conveyor belt speed, and hence also prevents a speed difference occurring between conveyor belt and conveyed goods and hence abrasion of the latter, which would result in soiling of the conveyor belt, is arranged closely above the horizontal conveyor leading to the packing station, which conveyor comprises substantially a conveyor belt.

### BRIEF DESCRIPTION OF THE DRAWINGS

An embodiment of an intermediate store according to the invention is described below with reference to the attached very schematic drawing. In the drawing,

FIG. 1 shows a side view of the substantial parts of an intermediate store according to the invention,

FIG. 2 shows an end view of the substantial parts in the direction of the arrow II of FIG. 1,

FIG. 3 shows an end view of the substantial parts in the direction of the arrow III of FIG. 1,

FIG. 4 shows a side view in a further phase of product movement,

FIG. 5 shows an end view in the direction of the arrow V of FIG. 4,

FIG. 6 shows an end view in the direction of the arrow VI of FIG. 4,

FIG. 7 and 8 show a schematic diagram of a detail of the design of the unloading station.

In order to be able to represent and describe the substantial features of the invention well, only the transport racks and—purely schematically—the various conveyors for the transport racks are shown in the drawing, not the guide rails and the other constructional details necessary for operating the store.

### DESCRIPTION OF THE PREFERRED EMBODIMENT

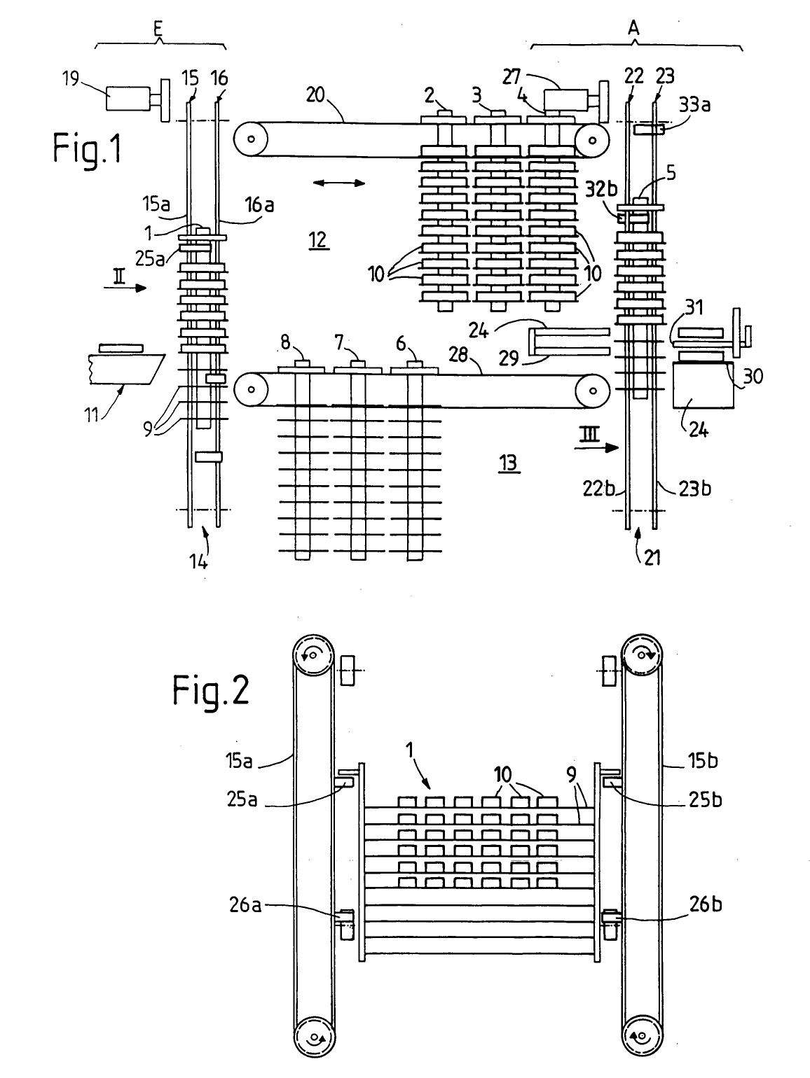

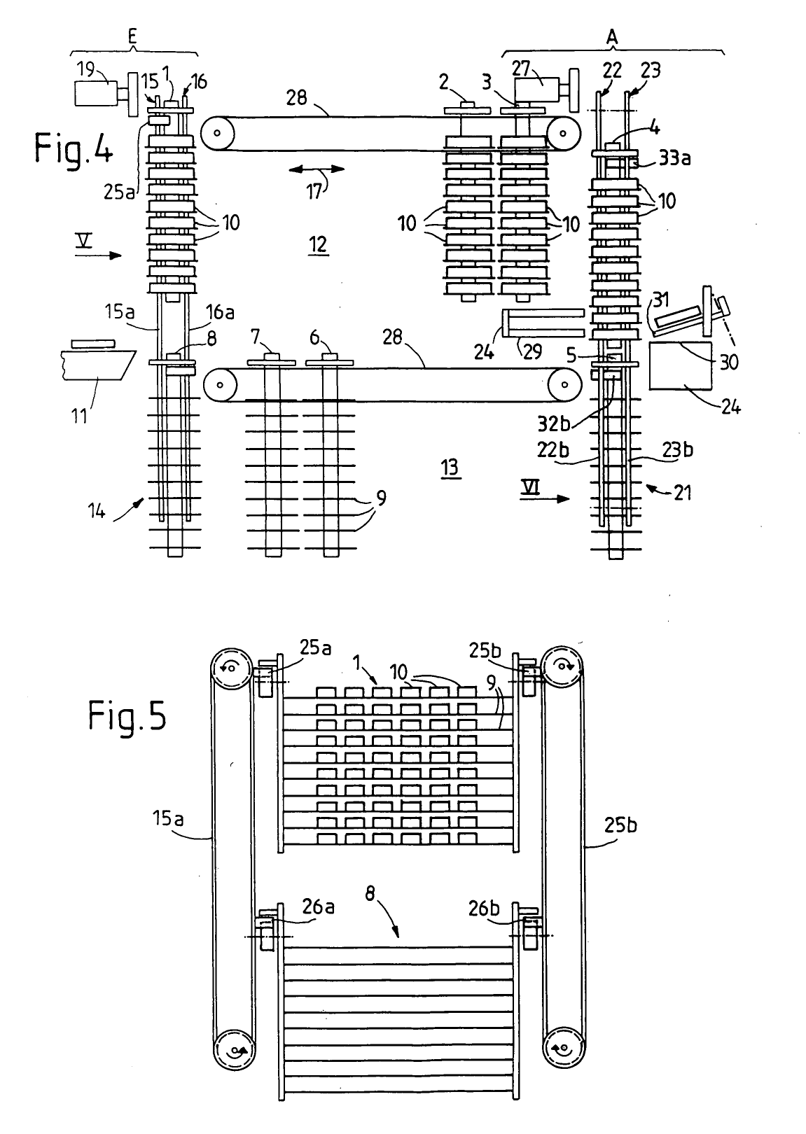

The intermediate store shown in the drawing contains eight transport racks, which are denoted by 1-8. Here, each of these transport racks is equipped with ten equidistant shelves 9, the size of the shelves and their mutual spacing being adapted to the size and the weight of the products 10 to be transported. The intermediate store has an input station E and an output station A and, between these two stations, two buffer zones, a first denoted by 12 for the loaded transport racks in the upper part of the store and a second denoted by 13 for the empty transport racks in the lower part of the store. Of course, each of the two buffer zones 12 and 13 must be so large that they can hold all except two of the transport racks present in the entire intermediate store, i.e. six in the example shown, which cannot be seen exactly in FIGS. 1 and 4.

The input station E contains a loading device which is indicated here only very schematically and is denoted by 11. The input station furthermore includes a vertical conveyor, which is denoted here as a whole by 14 and serves for transporting the empty transport racks fed from the second buffer zone 13, in synchronous operation, i.e. stepwise according to the spacing of the shelves 9, past the loading device 11 so that the individual shelves 9 of each transport container can be loaded there with the products fed from a production facility, i.e. for example with one row each of chocolate bars or biscuits. This vertical conveyor 14 has two pairs 15 and 16 of chains which are provided with drives independent on one another and of which the chains 15a and 16a can be seen in FIGS. 1 and 4 and the chains 15a and 15b of the pair 15 of chains in FIGS. 2 and 5, which for their part obscure the view of the chains 16a and 16b of the pair 16 of chains there.

From the drawing, it is evident that all four chains are arranged in such a way that each plane defined by the two sides of a chain is perpendicular to the transport direction 17 of the transport racks in the buffer zones 12 and 13.

In FIGS. 1 and 2, as many as six of the ten shelves 9 of the transport rack 1 have now been loaded. After the next upward step of the conveyor, the following, i.e. the seventh, shelf is loaded. Each chain has a driver for transporting the individual transport racks upward, for example the chain 15a has the driver 25a and the chain 15b has the driver 25b, both of which together transport the transport rack 1 upward. The chain 16a has the driver 26a and the chain 16b, which is not visible, has the driver 26b.

As soon as the last shelf, i.e. the tenth shelf 9 of this transport rack 1, has been loaded during the stepwise upward movement of the transport rack 1, those chains of the second pair 16 of chains which are each provided with a driver ensure, as is evident from FIGS. 4 and 5, that a following transport rack, which is denoted here by 8 and has been removed from the lower, i.e. the second, buffer zone 13 shortly before the loading of the tenth shelf of the transport rack 1, follows the transport rack 1 virtually without any space and is transported upward by this pair of chains in synchronous operation, i.e. stepwise, so that this transport rack 8 too can be loaded by the loading device 11. At the same time, the two chains 15a and 15b of the first pair 15 of chains transport the transport rack 1 completely to the top, where it is transferred to the buffer space conveyor 20 in the upper, i.e. first, buffer zone 12 by an aid 19 serving as a pusher. This is formed in such a way that the individual transport racks reach a point as close as possible to the exit present on the right in FIGS. 1 and 4 of the drawing, where they queue.

When the second transport rack 8 has been filled, it is, after being decoupled from synchronous operation, transported completely to the top and from there to the buffer space conveyor 20 in the upper first buffer zone 12.

In the meantime, however, the first pair 15a and 15b of chains has already accepted the following, i.e. the third, transport rack 7 and transported it upward so that it is adjacent to the second transport rack 8 virtually without any space, so that, on the one hand, the loading device 11 can operate without interruption and, on the other hand, no speed changes giving rise to rocking occur during the horizontal movement of the transport rack.

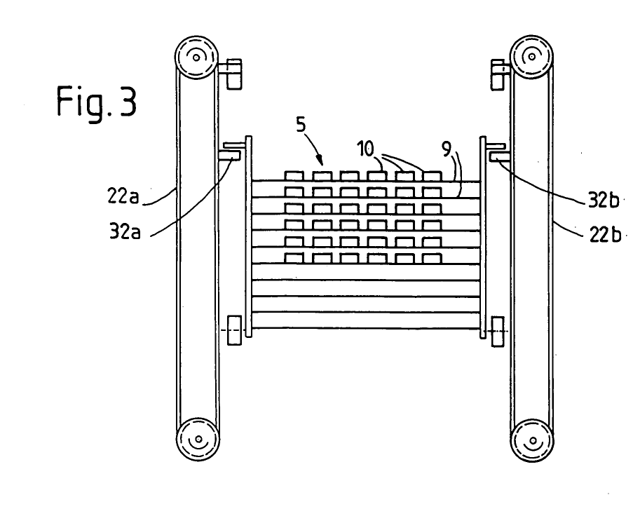

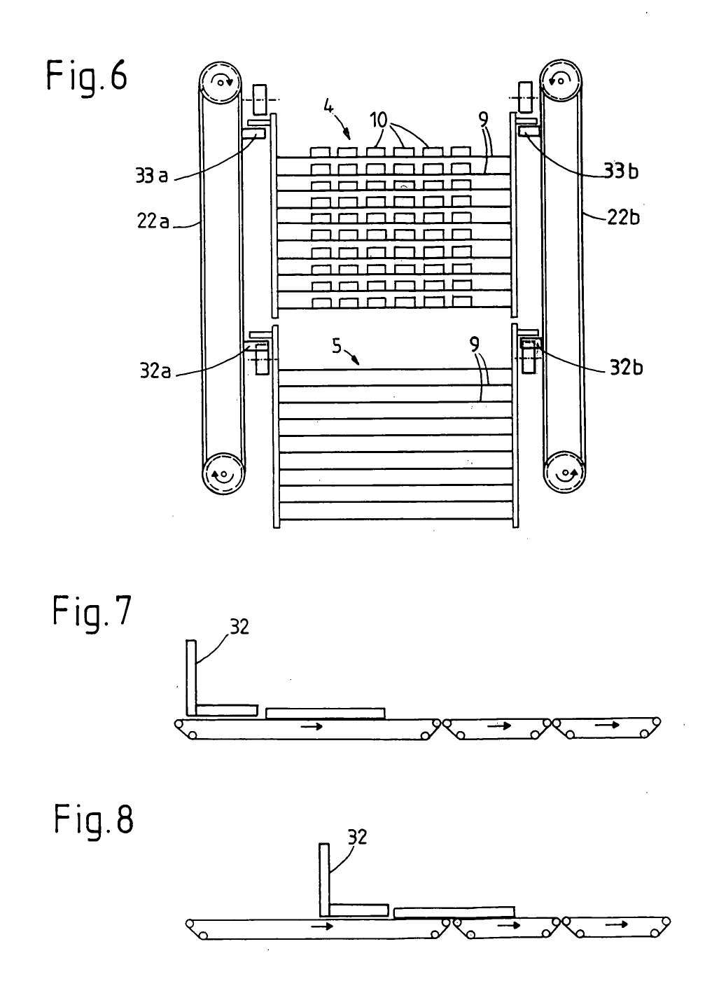

The output station A is designed analogously to the input station E: here, the vertical conveyor is denoted as a whole by 21. It serves for transporting the individual transport racks from top to bottom past the unloading device denoted as a whole by 24. It too has two pairs of chains denoted by 22 and 23 and provided with drives independent of one another, of which only the chains 22b and 23b can be seen in FIGS. 1 and 4 but the chains 22a and 22b of the pair 22 of chains can be seen in FIGS. 3 and 6.

The chain 22a has a driver 32a, the chain 22b has a driver 32b, the chain 23b has a driver 33b and the chain 23a, which is not visible, has a driver 33a. Here too, as can be seen in the drawing, all chains are arranged in such a way that the planes defined by the two sides are perpendicular to the displacement direction 17 of the transport racks in the buffer zones 12 and 13.

As shown in FIGS. 1 and 3, the pair 22a/22b of chains first transports the transport rack 5 stepwise downward past the unloading device 24 so that this unloading device can unload the individual shelves 9. Before the last shelf has been unloaded, the aid 27 in the form of a pusher transfers a full transport rack, i.e. the transport rack 4 in this case, to the vertical conveyor 21, in particular to its pair 23 of transport chains. Said pair of transport chains transports the transport rack downward so that it is adjacent to the transport rack 5 virtually without any space, so that the unloading device 24 can operate without interruption. The empty transport rack 5 is then transferred to the buffer space conveyor 28 in the lower, i.e. in the second, buffer zone 13. This buffer space conveyor 28 serves for moving the empty transport racks as far as possible to the left in FIGS. 1 and 4 so that they can be fed to the vertical conveyor 14 as required. Here too, the two pairs of chains which are independent of one another therefore ensure that there are no spaces between the individual transport racks in the vertical conveyor, i.e. there are no breaks during unloading.

Here, the unloading device 24 shown in FIGS. 1 and 4 has a dual pusher 29 which simultaneously pushes the product rows from two shelves 9 present one on top of the other onto a horizontal conveyor, namely from the lower shelf onto a conveyor belt 13 moving transversely to the output direction and from an upper shelf onto a storage plate 31 arranged above this conveyor belt 30. Said storage plate is formed so as to be either retractable or tiltable so that the product row present on it can be transferred to the conveyor belt underneath as soon as the lower product row of the two product rows simultaneously ejected has been transported away.

Depending on the type of product, it may be expedient to provide a scraper which pushes the product rows from the storage plate 31 onto the conveyor belt 30.

As shown in FIGS. 7 and 8, it is expedient to provide a motor-driven pusher bar 32 which pushes the product rows 10 placed on the conveyor belt, immediately after they have been set down, at the speed of the conveyor belt so that slipping of the conveyed goods on the conveyor belt is avoided.

1. An intermediate store serving for flexible decoupling of the product flow between a production facility and a further processing station and having a transport rack with equidistant shelves,
comprising an input station having a loading device and an output station having an unloading device, these two stations each being equipped with a vertical conveyor for the transport rack,
comprising two buffer conveyors arranged between these two stations intended for buffer zones containing the transport racks, a first one for the full transport racks and the second one for the empty transport racks,
and comprising aids for transferring the transport racks from the first vertical conveyor to the first buffer zone, from this to the second vertical conveyor, from this to the second buffer zone and from this to the first vertical conveyor,
wherein each of the two vertical conveyors has two pairs of chains which are provided with drives independent of one another and all of which are arranged so that the planes defined by the two sides of a chain are perpendicular to the transport direction of the transport racks in the buffer zones,
wherein the drives of the vertical conveyors are controlled so that an empty transport rack transferred to the input station is moved by the first pair of chains, initially in synchronous operation corresponding to the shelf spacing, past the loading device and is loaded there and, after the end of loading, is decoupled from the synchronous operation and fed to the first buffer zone (12),
wherein the subsequent empty transport rack transferred to the input station is accepted by the second pair of chains and follows the preceding transport rack without a gap in the same synchronous operation, is likewise decoupled from the synchronous operation after the end of loading and is fed to the first buffer zone, wherein the following transport rack is in turn accepted by the first pair of chains,
and wherein the full transport racks transferred to the output station are moved in an analogous manner, alternately by the two pairs of chains, in synchronous operation, past the unloading device, are unloaded there and are then decoupled from the synchronous operation and fed to the second buffer zone.

2. The intermediate store as claimed in claim 1, wherein all chains of the two vertical conveyors are provided with drivers and all drivers lie at least approximately in a single vertical plane which is perpendicular to the transport direction of the transport racks in the buffer zones.

3. The intermediate store as claimed in claim 1, wherein the unloading device contains a dual pusher for the simultaneous ejection of the products from two shelves one on top of the other, and a conveyor belt in the form of a horizontal conveyor and a storage plate arranged above this.

4. The intermediate store as claimed in claim 3, wherein the storage plate is one of horizontally displaceable and of tiltable, so that the products placed on it can be placed on the conveyor belt present under it.

5. The intermediate store as claimed in claim 3, wherein a scraper is arranged just above the receiving plane of the storage plate, in order to scrape the product row from the storage plate onto the conveyor belt.

6. The intermediate store as claimed in claim 1, a horizontal conveyor leading to the packing station being located downstream of the unloading station, wherein a pusher bar coupled to a servo drive is arranged closely above the transport plane of this conveyor, the movement of which pusher bar is tailored to the loading cadence of the unloading device in such a way that it pushes each product row, arriving on the conveyor, at the transport speed of the conveyor.
